(19) United States
(12) Patent Application Publication
(10) Pub. No.: US 2020/0005297 A1
(43) Pub. Date: Jan. 2, 2020

(54) DECOY BILLING ADDRESS

(71) Applicant: Capital One Services, LLC, McLean, VA (US)

(72) Inventors: Joshua Edwards, Philadelphia, PA (US); Abdelkader Benkreira, Washington, DC (US); Michael Mossoba, Arlington, VA (US)

(73) Assignee: Capital One Services, LLC, McLean, VA (US)

(21) Appl. No.: 16/021,961

(22) Filed: Jun. 28, 2018

(51) Int. Cl. G06Q 20/40

(52) U.S. Cl. CPC G06Q 20/401

(57) ABSTRACT

Embodiments disclosed herein generally relate to a system and method for obfuscating personal identification information. A computing system receives, from a remote computing system associated with a third party merchant, user credentials. The computing system parses the user credentials to extract an account number and a verification address. The computing system identifies a user account associated with the extracted account number. The computing system identifies that the verification address is different from a billing address in the user account. The computing system determines that a decoy billing address exists for the user. The computing system determines that the received billing address matches the decoy billing address for the user. The computing system verifies the transaction with the third party merchant by transmitting a verification message to the remote computing system, without revealing the stored billing address in the user account.

### FIELD OF THE DISCLOSURE

The present disclosure generally relates to a method and a system for verifying a customer's transaction using obfuscated personal identification information.

### BACKGROUND

Currently, there are various means in which consumers may transact with third party vendors. Credit card products are one instrument that are offered and provided to consumers by credit card issuers (e.g., banks and other financial institutions). With a credit card, an authorized consumer is capable of purchasing services and/or merchandise without an immediate, direct exchange of cash. Rather, the consumer incurs debt with each purchase. Debit cards are another type of instrument offered and provided by banks (or other financial institutions) that are associated with the consumer's bank account (e.g., checking account). Transactions made using a debit card are cleared directly from the cardholder's bank account. Still further, in the digital age, a consumer may use a computing device, such as a mobile phone, to perform various transactions.

### SUMMARY

Embodiments disclosed herein generally relate to a system and method for obfuscating personal identification information. In one embodiment, a method is disclosed herein. A computing system receives, from a remote computing system associated with a third party merchant, user credentials. The user credentials include at least an account number and a verification address of a user attempting to perform a transaction with the third party merchant. The computing system parses the user credentials to extract the account number and the verification address. The computing system identifies a user account associated with the extracted account number. The computing system identifies that the verification address is different from a billing address in the user account. The computing system determines that a decoy billing address exists for the user. The decoy billing address is a string of characters defined by the user. The computing system determines that the received billing address matches the decoy billing address for the user. The computing system verifies the transaction with the third party merchant by transmitting a verification message to the remote computing system, without revealing the stored billing address in the user account.

In some embodiments, the verification address is of a form that is inconsistent with billing addresses.

In some embodiments, the verification address is a partial address.

In some embodiments, the computing system receives, from a client device of the user, a request to change the decoy billing address. The computing system receives, from the client device of the user, an updated decoy billing address. The computing system updates the user account with the updated decoy billing address.

In some embodiments, the computing system receives, from a client device of the user, a request to change the decoy billing address. The computing system, upon receiving the request, automatically generates an updated decoy billing address for the user. The computing system transmits the updated decoy billing address to the user. The computing system updates the user account with the updated decoy billing address.

In some embodiments, receiving the request to change the decoy billing address includes the computing system receiving a level of difficulty from the client device of the user. The level of difficulty corresponds to a password complexity level.

In some embodiments, the computing system receives, from a second remote computing system associated with a second third party merchant, a second set of user credentials. The second set of user credentials includes at least the account number and a second verification address of the user attempting to perform a second transaction with the second third party. The computing system identifies the user account associated with the extracted account number. The computing system identifies that the decoy billing address exists for the user. The computing system determines that the second verification address matches the billing address associated with the user account and does not match the decoy billing address. The computing system rejects the second transaction with the second third party merchant by transmitting a rejection message to the second remote computing system.

In another embodiment, a method is disclosed herein. A computing system receives, from a client device associated with a user, a decoy billing address. The decoy billing address is different from a billing address of the user. The computing system associates the decoy billing address with a verification address. The verification address is used by the user to verify the user during a transaction with one or more third party merchants. The computing system stores the association between the decoy billing address and the verification address in a user account associated with the user. The computing system receives, from a remote computing system associated with a third party merchant of the one or more third party merchants, user credentials. The user credentials include at least an account number and the verification address of the user attempting to perform a transaction with the third party merchant. The computing system parses the user credentials to extract the account number and the verification address. The computing system identifies the user account associated with the extracted account number. The computing system determines that a decoy billing address exists for the user. The computing system determines that the received verification address matches the decoy billing address for the user. The computing system verifies the transaction with the third party merchant by transmitting a verification message to the remote computing system, without revealing the stored billing address in the user account.

In some embodiments, the verification address is of a form that is inconsistent with billing addresses.

In some embodiments, the verification address is a partial address.

In some embodiments, the computing system receives, from the client device of the user, a request to change the decoy billing address. The computing system receives, from the client device of the user, an updated decoy billing address. The computing system associates the updated decoy billing address with the verification address. The computing system updates the user account with the association.

In some embodiments, the computing system receives, from a client device of the user, a request to change the decoy billing address. The computing system upon receiving the request, automatically generates an updated decoy billing address for the user. The computing system transmits the updated decoy billing address to the user. The computing system associates the updated decoy billing address with the verification address. The computing system updates the user account with the association.

In some embodiments, receiving the request to change the decoy billing address includes the computing system receiving a level of difficulty from the client device of the user, wherein the level of difficulty corresponds to a password complexity level.

In some embodiments, the computing system receives, from a second remote computing system associated with a second third party merchant, a second set of user credentials. The second set of user credentials includes at least the account number and a second verification address of the user attempting to perform a second transaction with the second third party. The computing system identifies the user account associated with the extracted account number. The computing system identifies that the decoy billing address exists for the user. The computing system determines that the second verification address of the user matches the billing address associated with the user account and does not match the decoy billing address. The computing system rejects the second transaction with the second third party merchant by transmitting a rejection message to the second remote computing system.

In another embodiment, a system is disclosed herein. The system includes a processor and a memory. The memory includes programming instructions stored thereon, which, when executed by the processing, performs an operation. The operation includes receiving, from a remote computing system associated with a third party merchant, user credentials. The user credentials include at least an account number and a verification address of a user attempting to perform a transaction with the third party merchant. The operation includes identifying a user account associated with the extracted account number. The operation includes determining that a decoy billing address exists for the user. The decoy billing address includes a string of characters defined by the user that is different from a stored billing address associated with the user account. The operation includes determining that the received billing address matches the decoy billing address for the user. The operation includes verifying the transaction with the third party merchant by transmitting a verification message to the remote computing system, without revealing the stored billing address in the user account.

In some embodiments, the verification address is of a form that is inconsistent with billing addresses.

In some embodiments, the verification address is a partial address.

In some embodiments, the operation further includes receiving, from a client device of the user, a request to change the decoy billing address. The operation includes receiving, from the client device of the user, an updated decoy billing address. The operation includes updating the user account with the updated decoy billing address.

In some embodiments, the operation further includes receiving, from a client device of the user, a request to change the decoy billing address. The operation includes, upon receiving the request, automatically generating an updated decoy billing address for the user. The operation includes transmitting the updated decoy billing address to the user. The operation includes updating the user account with the updated decoy billing address.

In some embodiments, the operation further includes receiving, from a second remote computing system associated with a second third party merchant, a second set of user credentials comprising at least the account number and a second verification address of the user attempting to perform a second transaction with the second third party. The operation includes identifying the user account associated with the extracted account number. The operation includes identifying that the decoy billing address exists for the user. The operation includes determining that the second verification address matches the billing address associated with the user account and does not match the decoy billing address. The operation includes rejecting the second transaction with the second third party merchant by transmitting a rejection message to the second remote computing system.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to one exemplary embodiment.

FIG. 2A is a flow diagram illustrating a method of generating a decoy billing address, according to one exemplary embodiment.

FIG. 2B is a flow diagram illustrating a method of generating a decoy billing address, according to one exemplary embodiment.

FIG. 3 is a flow diagram of authentication a transaction with a third party vendor, according to one exemplary embodiment.

FIG. 4 is a block diagram illustrating a computing environment, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

When a consumer uses a payment device (e.g., credit card, debit card, checking card, etc.), to purchase goods and services, the transaction may be monitored by an authorization system that follows certain security protocols to ensure that the customer is authorized to use the payment device for the purchase transaction. For example, in a typical transaction, after the consumer transmits his or her personal identification information (e.g., card number, cardholder name, card expiration date, card security code, and the like) the third party vendor may request verification information that is transmitted to a verification service (e.g., the financial institution associated with the payment information) for authentication/verification. In some embodiments, the verification service may request verification information in the form of a billing address to further verify the user's transaction.

Billing addresses may be one of the least secure forms of verification used by financial institutions. Typically, the billing address of an individual may be identical, or similar to, the home address of the individual. In these situations, the billing address of an individual may be deduced by a simple Internet search of the individual's address, interception of the individual's mail, or similar means. One or more techniques disclosed herein addresses this deficiency of conventional verification techniques by providing a decoy billing address agent that is configured to generate a decoy billing address that masks (or obfuscates) the billing address of the individual. The decoy billing address may be used by the individual to validate (or verify) future transactions. As such, by letting the individual define or request a decoy billing address, the individual takes proactive steps to further protect his or her financial information.

The term “user” as used herein includes, for example, a person or entity that owns a computing device or wireless device; a person or entity that operates or utilizes a computing device; or a person or entity that is otherwise associated with a computing device or wireless device. It is contemplated that the term “user” is not intended to be limiting and may include various examples beyond those described.

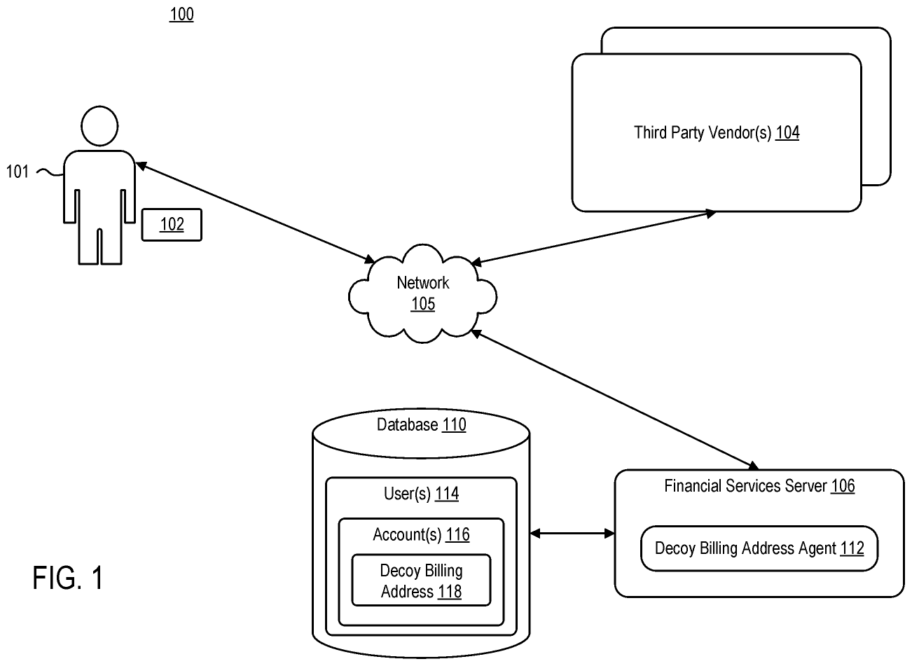

FIG. 1 is a block diagram illustrating a computing environment 100, according to one embodiment. Computing environment 100 may include at least a user 101 operating payment device 102, one or more third party vendors 104, and a financial services server 106 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may include any type of computer networking arrangement used to exchange information. For example, network 105 may be the Internet, a private data network, virtual private network using a public network and/or other suitable connection(s) that enables components in computing environment 100 to send and receiving information between the components of system 100.

Third party vendors 104 may comprise one or more computing systems associated with a third party vendor (e.g., third party merchant). In operation, user 101 may transact with a third party vendor 104 via client device 102. In some embodiments, client device 102 may be representative of a user's personal device (e.g., desktop computer, laptop, mobile device, tablet, etc.). For example, user 101 may conduct a “card not present transaction” in which user 101 does not physically present a payment card to third party vendor 104 during a transaction. In some embodiments, client device 102 may be representative of a payment card (e.g., credit card, debit card, gift card, etc.). For example, user 101 may conduct a “card present” transaction in which user 101 physically presents a payment card to third party vendor 104 during a transaction (e.g., physical swipe via magnetic strip or physical insertion via EMV chip).

Financial services server 106 may comprise one or more computing systems associated with a financial services organization. Financial services server 106 may be configured to manage information associated with a user's (e.g., user 101) account. Financial services server 106 may be in communication with database 110. Database 110 may include information associated with one or more users 114. Each user 114 may have one or more accounts 116 associated therewith. Account 116 may be representative of a credit card account, a savings account, a checking account, and the like.

In some embodiments, financial services server 106 may be configured to verify one or more user credentials with third party vendors 104. In operation, some third party vendors 104 may require further information from user 101 to complete the transaction. For example, some third party vendors 104 may require user 101 to provide a billing address or a partial billing address (e.g., billing zip code) to further verify the transaction. To verify the transaction, third party vendor 104 may communicate with financial services server 106 via network 105. For example, third party vendor 104 may transmit user information that includes one or more of a name of the cardholder, credit card number, expiration date, credit card security code, and submitted billing address. Financial services server 106 may in turn send a message back to third party vendor 104 either verifying or rejecting the transaction attempt.

Conventionally, a customer's (e.g., user 101) billing address may be a readily accessible piece of data. For example, a customer's billing address is typically the same as the customer's mailing address. As such, the customer's billing address may be easily compromised by fraudsters. One or more techniques disclosed herein addresses the downfalls of conventional techniques of using a billing address as a further piece of verification. To address this, financial services server 106 may include a decoy billing address agent 112. Decoy billing address agent 112 may be configured to communicate with user 101 to define a decoy (or proxy) address to be used in place of the traditional billing address. In some embodiments, decoy billing address agent 112 may be configured to generate a decoy billing address for user 101, and transmit the decoy billing address to user 101 for future use. In some embodiments, decoy billing address agent 112 may be configured to receive a decoy billing address from user 101. In both embodiments, decoy billing address agent 112 may store the decoy billing address in database 110. For example, as illustrated, user's 101 account 116 may include decoy billing address 118 that may be used as a further verification metric.

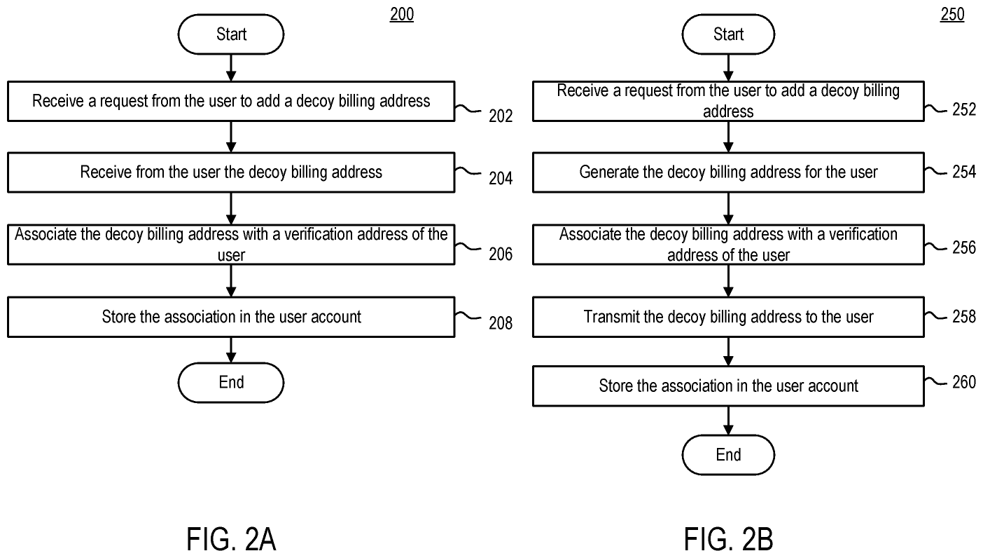

FIG. 2A is a flow chart illustrating a method 200 of generating a decoy billing address, according to one exemplary embodiment. Method 200 may begin at step 202. At step 202, financial services server 106 may receive a request from user 101 to add a decoy billing address. For example, user 101 may access financial services server 106 via a mobile or desktop application to request a decoy billing address.

At step 204, financial services server 106 may receive from user 101 the decoy billing address. For example, user 101 may generate a decoy billing address and transmit the decoy billing address to financial services server 106.

At step 206, financial services server 106 may associate the decoy billing address with a verification address of the user. For example, rather than financial services server 106 associating user's 101 traditional billing address with the verification address, decoy billing address agent 112 may associate the received decoy billing address with the verification address.

At step 208, financial services server 106 may store the association in database 110. For example, decoy billing address agent 112 may store the association in database 110 as decoy billing address 118.

FIG. 2B is a flow chart illustrating a method 250 of generating a decoy billing address, according to one exemplary embodiment. Method 250 begins at step 252. At step 252, financial services server 106 may receive a request from user 101 to add a decoy billing address. For example, user 101 may access financial services server 106 via a mobile or desktop application to request a decoy billing address. In some embodiments, the request received from user 101 may include a level of difficulty for the decoy billing address. The level of difficulty may correspond to a complexity of the decoy billing address.

At step 254, financial service server 106 may generate a decoy billing address for user 101. For example, decoy billing address agent 112 may generate the decoy billing address based on the level of difficulty specified by user 101 in the request. In some embodiments, decoy billing address may only include a partial billing address, such as a billing zip code. In some embodiments, decoy billing address may be a complete billing address (i.e., street address, city, state, zip code). In some embodiments, decoy billing address may be in the form of a string of characters that does not mimic address information. For example, decoy billing address may be: “qw23r39ac”.

At step 256, financial services server 106 may associate the decoy billing address with a verification address of the user. For example, rather than financial services server 106 associating user's 101 traditional billing address with the verification address, decoy billing address agent 112 may associate the received decoy billing address with the verification address.

At step 258, financial services server 106 may transmit the decoy billing address to user 101. For example, financial services server 106 may transmit the decoy billing address to user 101, so that user 101 is knowledgeable of information to be used in future transactions. Further, by transmitting the decoy billing address to user 101, financial services server 106 may allow the user to generate a new address if the transmitted decoy billing address was not sufficient (e.g., the user did not like the generated decoy billing address). As such, the decoy billing address may be temporarily stored on financial services server 106.

At step 260, financial services server 106 may store the association in database 110. For example, decoy billing address agent 110 may store the association in database 110 at decoy billing address 118. For example, financial services server 106 may move the decoy billing address from temporary storage to database 110 upon confirmation from the user.

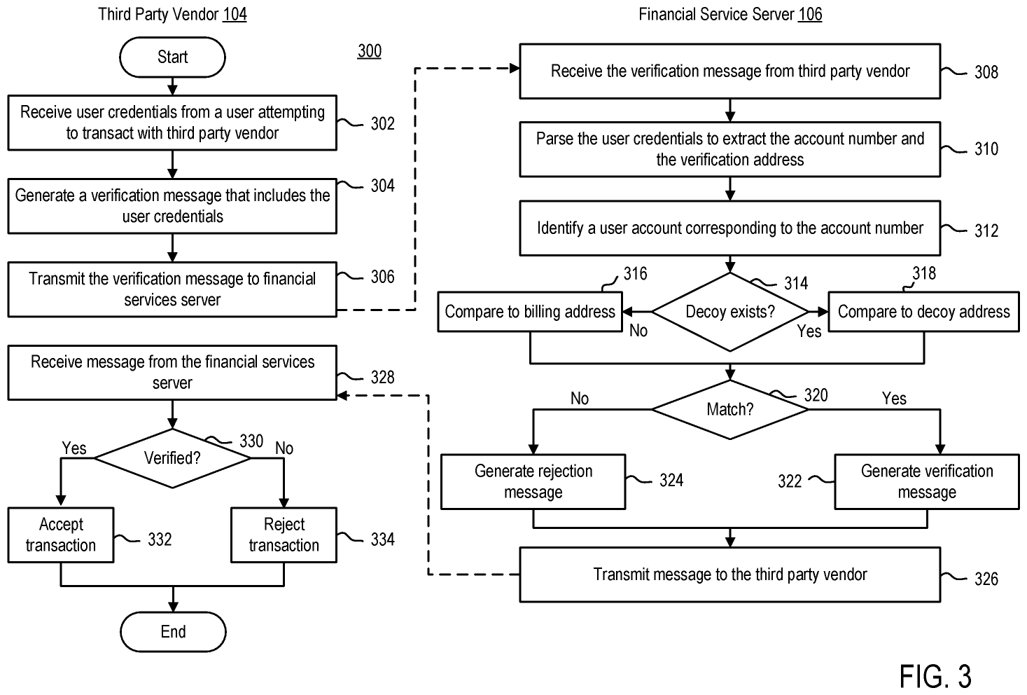

FIG. 3 is a flow diagram illustrating a method 300 of obfuscating personal identification information, according to one exemplary embodiment. Method 300 begins at step 302. At step 302, third party vendor 104 may receive one or more user credentials from a user attempting to transact with third party vendor 104. One or more user credentials may include, for example, a cardholder name, a payment card number, a payment card expiration date, a payment card CSC, and a verification address. In some embodiments, the transaction between third party vendor 104 and user 101 is a “card not present” transaction. In some embodiments, the transaction between third party vendor 104 and user 101 is a “card present” transaction.

At step 304, third party vendor 104 may generate a verification message to be transmitted to financial services server 106. Verification message may include the one or more user credentials received from user 101. For example, the verification message may include at least a cardholder name, a payment card number, a payment card expiration date, a payment card CSC, and a verification address.

At step 306, third party vendor 104 may transmit verification message to financial services server 106. For example, third party vendor 104 may transmit verification message to financial services server 106 via network 105. At step 308, financial services server 106 may receive verification message from third party vendor 104.

At step 310, financial services server 106 may parse the one or more user credentials to extract at least an account number (e.g., payment card number) and verification address contained therein. For example, decoy billing address agent 112 may parse the one or more user credentials to extract at least a payment card number to identify an account with financial services server 106 and a verification address to verify the transaction.

At step 312, financial services server 106 may identify a user account corresponding to the account number. For example, decoy billing address agent 112 may query database 110 to identify the user account corresponding to the account number.

At step 314, financial services server 106 may determine whether a decoy billing address exists for user 101. For example, decoy billing address agent 112 may parse account 116 to determine whether a decoy billing address exists.

If, at step 314, financial services server 106 determines that a decoy billing address does not exist, then at step 316, financial services server 106 may compare the verification address to the billing address in account 116. If, however, at step 314, financial services server 106 determines that a decoy billing address does exist, then at step 318, financial services server 106 may compare the verification address to decoy billing address 118 in account 116.

At step 320, financial services server 106 may determine whether a match exists between verification address and the address on file (e.g., billing address or decoy billing address). If, at step 320, financial services server 106 determines that a match exists between the address on file and verification address, then at step 322, financial services server 106 generates a verification address to be sent to third party vendor 104. If, however, at step 320, financial services server 106 determines that a match does not exist between the address on file and verification address, then at step 322, financial services server 106 generates a rejection address to be sent to third party vendor 104.

At step 326, financial services server 106 may transmit the message to third party vendor 104. For example, financial services server 106 may transmit the message to third party vendor 104 via network 105.

At step 328, third party vendor 104 may receive the message from financial services server 106. At step 330, third party vendor 104 may determine whether financial services server 106 verified the transaction. If, at step 330, third party vendor 104 determines that financial services server 106 verified the transaction, then at step 332, third party vendor 104 may accept user's 101 transaction attempt. If, however, at step 330, third party vendor 104 determines that financial services server 106 did not verify the transaction, then at step 334, third party vendor 104 may reject user's 101 transaction attempt.

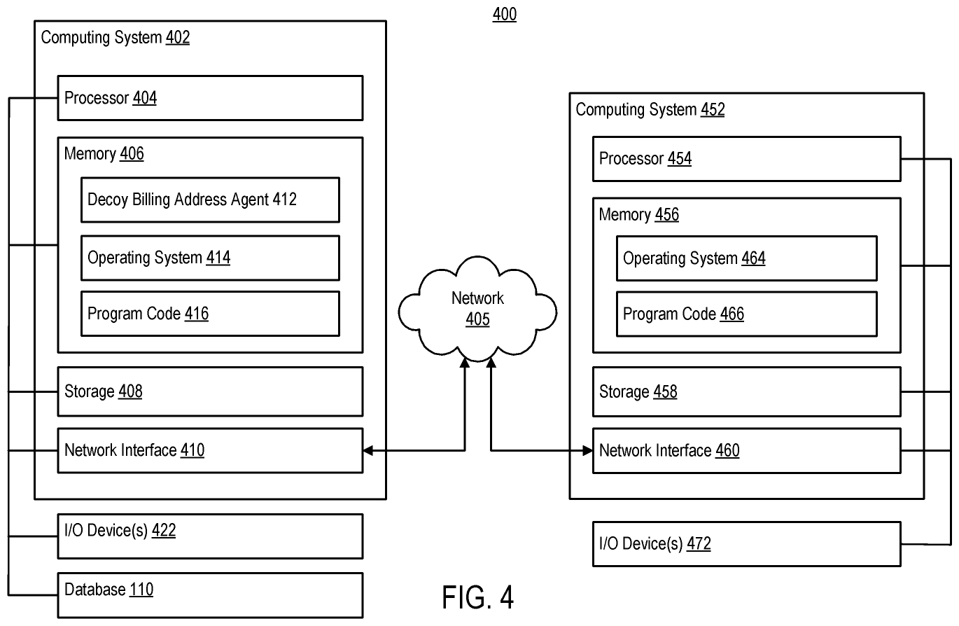

FIG. 4 is a block diagram illustrating an exemplary computing environment 400, according to some embodiments. Computing environment 400 may include computing system 402 and computing system 452. Computing system 402 may be representative of a computing system of financial services server 106. Computing system 452 may be representative of a computing system of third party vendor 104.

Computing system 402 may include a processor 404, a memory 406, a storage 408, and a network interface 410. In some embodiments, computing system 402 may be coupled to one or more I/O device(s) 422 (e.g., keyboard, mouse, etc.). In some embodiments, computing system 402 may be further coupled to database 110.

Processor 404 retrieves and executes program code 416 (i.e., programming instructions) stored in memory 406, as well as stores and retrieves application data. Processor 404 is included to be representative of a single processor, multiple processors, a single processor having multiple processing cores, and the like. Network interface 410 may be any type of network communications allowing computing system 452 to communicate externally via computing network 405. For example, network interface 410 is configured to enable external communication with computing system 452.

Storage 408 may be, for example, a disk storage device. Although shown as a single unit, storage 408 may be a combination of fixed and/or removable storage devices, such as fixed disk drives, removable memory cards, optical storage, network attached storage (NAS), storage area network (SAN), and the like.

Memory 406 may include decoy billing address agent 412, operating system 414, and program code 416. Program code 416 may be accessed by processor 404 for processing (i.e., executing program instructions). Program code 416 may include, for example, executable instructions for communicating with computing system 452 to verify a user's payment with obscured personal identification information. Decoy billing address agent 412 may be configured to communicate with user to define a decoy (or proxy) address to be used in place of the traditional billing address. In some embodiments, decoy billing address agent 412 may be configured to generate a decoy billing address for user, and transmit the decoy billing address to user for future use. Decoy billing address agent 412 may be further in communication with computing system 452. For example, decoy billing address agent 412 may receive one or more verification requests from computing system 452 to verify a user's transaction.

Computing system 452 may include a processor 454, a memory 456, a storage 458, and a network interface 460. In some embodiments, computing system 452 may be coupled to one or more I/O device(s) 472.

Processor 454 retrieves and executes program code 466 (i.e., programming instructions) stored in memory 456, as well as stores and retrieves application data. Processor 454 is included to be representative of a single processor, multiple processors, a single processor having multiple processing cores, and the like. Network interface 460 may be any type of network communications enabling computing system 452 to communicate externally via computing network 405. For example, network interface 460 allows computing system 452 to communicate with computer system 402.

Storage 458 may be, for example, a disk storage device. Although shown as a single unit, storage 458 may be a combination of fixed and/or removable storage devices, such as fixed disk drives, removable memory cards, optical storage, network attached storage (NAS), storage area network (SAN), and the like.

Memory 456 may include operating system 464 and program code 466. Program code 466 may be accessed by processor 454 for processing (i.e., executing program instructions). Program code 466 may include, for example, executable instructions configured to perform steps discussed above in conjunction with FIG. 3. As an example, processor 454 may access program code 466 to perform operations for verifying a transaction with a customer using obfuscated personal identification information.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising
receiving, by a computing system from a remote computing system associated with a a first third party merchant, a first transaction request for a user, the first transaction request comprising user credentials comprising at least an account number and a verification address of the user attempting to perform a first transaction with the first third party merchant;
authenticating, by the computing system, the first transaction request by:
parsing the user credentials to extract the account number and the verification address;
identifying a user account associated with the extracted account number;
identifying that the verification address is different from a billing address in the user account;
determining that a decoy billing address exists for the user, the decoy billing address comprising a string of characters defined by the user; and
determining that the received verification address matches the decoy billing address for the user;
verifying, by the computing system, the first transaction request with the first third party merchant by transmitting a a first verification message to the first remote computing system, without revealing the stored billing address in the user account:,
receiving, by the computing system from a second remote computing system associated with a second third party merchant, a second transaction request for the user, the second transaction request comprising the user credentials;
authenticating, by the computing system, the second transaction request by:
parsing the user credentials to extract the account number and the verification address;
identifying the user account associated with the extracted account number;
identifying that the verification address is different from the billing address in the user account;
determining that the decoy billing address exists for the user; and
determining that the received verification address matches the decoy billing address for the user; and
verifying, by the computing system, the second transaction request with the second third party merchant by transmitting a second verification message to the second remote computing system, without revealing the stored billing address in the user account.

2. The method of claim 1, wherein the verification address does not correspond to a valid addresses.

3. The method of claim 1, wherein the verification address is a partial address.

4. The method of claim 1, further comprising:
receiving, by the computing system, from a client device of the user, a request to change the decoy billing address;
receiving, by the computing system from the client device of the user, an updated decoy billing address; and
updating, by the computing system, the user account with the updated decoy billing address.

5. The method of claim 1, further comprising:
receiving, by the computing system from a client device of the user, a request to change the decoy billing address;
upon receiving the request, automatically generating, by the computing system, an updated decoy billing address for the user;
transmitting, by the computing system, the updated decoy billing address to the user; and
updating, by the computing system, the user account with the updated decoy billing address.

6. The method of claim 5, wherein receiving, by the computing system, the request to change the decoy billing address comprises:
receiving a level of difficulty specified by the user of the client device, wherein the level of difficulty corresponds to a password complexity level.

7. The method of claim 1, further comprising:
receiving, by the computing system from a third remote computing system associated with a third third party merchant, a third set of user credentials comprising at least the account number and a third verification address of the user attempting to perform a third transaction with the third third party merchant;
identifying, by the computing system, the user account associated with the extracted account number;
identifying, by the computing system, that the decoy billing address exists for the user;
determining, by the computing system, that the third verification address matches the billing address associated with the user account and does not match the decoy billing address; and
rejecting, by the computing system, the third transaction with the third third party merchant by transmitting a rejection message to the third remote computing system.

8. A method, comprising:
receiving, by a computing system from a client device associated with a user, a decoy billing address, the decoy billing address different from a billing address of the user;
associating, by the computing system, the decoy billing address with a verification address, wherein the verification address is used by the user to verify the user during a transaction with one or more third party merchants;
storing, by the computing system, the association between the decoy billing address and the verification address in a user account associated with the user;
receiving, by the computing system from a remote computing system associated with a first third party merchant, a transaction request for the user, the transaction request comprising user credentials comprising at least an account number and the verification address of the user attempting to perform a first transaction with the first third party merchant;
authenticating, by the computing system, the first transaction request by:
parsing the user credentials to extract the account number and the verification address;
identifying the user account associated with the extracted account number;
determining that a decoy billing address exists for the user; and
determining that the received verification address matches the decoy billing address for the user;
verifying, by the computing system, the first transaction request with the first third party merchant by transmitting a first verification message to the remote computing system, without revealing the stored billing address in the user account:,
receiving, by the computing system from a second remote computing system associated with a second third party merchant, a second transaction request for the user, the second transaction request comprising the user credentials;
authenticating, by the computing system, the second transaction request by:
parsing the user credentials to extract the account number and the verification address;
identifying the user account associated with the extracted account number;
identifying that the verification address is different from the billing address in the user account;
determining that the decoy billing address exists for the user; and
determining that the received verification address matches the decoy billing address for the user; and
verifying, by the computing system, the second transaction request with the second third party merchant by transmitting a second verification message to the second remote computing system, without revealing the stored billing address in the user account.

9. The method of claim 8, wherein the verification address does not correspond to a valid addresses.

10. The method of claim 8, wherein the verification address is a partial address.

11. The method of claim 8, further comprising:
receiving, by the computing system, from a client device of the user, a request to change the decoy billing address;
receiving, by the computing system from the client device of the user, an updated decoy billing address; and
updating, by the computing system, the user account with the updated decoy billing address.

12. The method of claim 8, further comprising:
receiving, by the computing system from a client device of the user, a request to change the decoy billing address;
upon receiving the request, automatically generating, by the computing system, an updated decoy billing address for the user;
transmitting, by the computing system, the updated decoy billing address to the user; and
updating, by the computing system, the user account with the updated decoy billing address.

13. The method of claim 12, wherein receiving, by the computing system, the request to change the decoy billing address comprises:
receiving a level of difficulty specified by the user of the client device, wherein the level of difficulty corresponds to a password complexity level.

14. The method of claim 8, further comprising:
receiving, by the computing system from a third remote computing system associated with a third third party merchant, a third set of user credentials comprising at least the account number and a third verification address of the user attempting to perform a third transaction with the third third party merchant;
identifying, by the computing system, the user account associated with the extracted account number;
identifying, by the computing system, that the decoy billing address exists for the user;
determining, by the computing system, that the third verification address matches the billing address associated with the user account and does not match the decoy billing address; and
rejecting, by the computing system, the third transaction with the third third party merchant by transmitting a rejection message to the third remote computing system.

15. A system, comprising:
a processor; and
a memory having programming instructions stored thereon, which, when executed by the processor, performs an operation comprising:
receiving, from a plurality of remote computing system systems associated with a plurality of third party merchants a first third party merchant, a plurality of transaction requests a first transaction request for a user, the first transaction request comprising user credentials comprising at least an account number and a verification address of the user attempting to perform a first transaction with a respective the first third party merchant;
authenticating the first transaction by:
identifying a user account associated with the extracted account number;
determining that a decoy billing address exists for the user, the decoy billing address comprising a string of characters defined by the user that is different from a stored billing address associated with the user account; and
determining that the received verification address matches the decoy billing address for the user;
verifying the first transaction request with each respective the first third party merchant by transmitting a plurality of verification messages a first verification message to the plurality of remote computing systems first remote computing system, without revealing the stored billing address in the user account:,
receiving, from a second remote computing system associated with a second third party merchant, a second transaction request for the user, the second transaction request comprising the user credentials;
authenticating the second transaction request by:
parsing the user credentials to extract the account number and the verification address;
identifying the user account associated with the extracted account number;
identifying that the verification address is different from the billing address in the user account;
determining that the decoy billing address exists for the user; and
determining that the received verification address matches the decoy billing address for the user; and
verifying the second transaction request with the second third party merchant by transmitting a second verification message to the second remote computing system, without revealing the stored billing address in the user account.

16. The system of claim 15, wherein the verification address does not correspond to a valid addresses.

17. The system of claim 15, wherein the verification address is a partial address.

18. The system of claim 15, further comprising:
receiving, from a client device of the user, a request to change the decoy billing address;
receiving, from the client device of the user, an updated decoy billing address; and
updating the user account with the updated decoy billing address.

19. The system of claim 15, further comprising:
receiving, from a client device of the user, a request to change the decoy billing address;
upon receiving the request, automatically generating an updated decoy billing address for the user;
transmitting the updated decoy billing address to the user; and
updating the user account with the updated decoy billing address.

20. The system of claim 15, wherein the operation further comprises:
receiving, from a third remote computing system associated with a third third party merchant, a third set of user credentials comprising at least the account number and a third verification address of the user attempting to perform a third transaction with the third third party merchant;
identifying the user account associated with the extracted account number;
identifying that the decoy billing address exists for the user;
determining that the third verification address matches the billing address associated with the user account and does not match the decoy billing address; and
rejecting the third transaction with the third third party merchant by transmitting a rejection message to the third remote computing system.
